(19) United States
(12) Patent Application Publication
(10) Pub. No.: US 2017/0001449 A1
(43) Pub. Date: Jan. 5, 2017

(54) INKJET PRINTING APPARATUS, METHOD FOR MANUFACTURING PRINTED MATTER, PROGRAM, AND RECORDING MEDIUM

(71) Applicant: MIMAKI ENGINEERING CO., LTD., Tomi-city (JP)

(72) Inventors: AKIRA TAKATSU, NAGANO (JP); KAZUHIRO OCHI, NAGANO (JP); ATSUSHI TSUCHIYA, NAGANO (JP)

(73) Assignee: MIMAKI ENGINEERING CO., LTD., NAGANO (JP)

(21) Appl. No.: 15/115,269

(22) PCT Filed: Jan. 21, 2015
(86) PCT No.: PCT/JP2015/051481

§ 371 Date: Jul. 29, 2016

(30) Foreign Application Priority Data
Jan. 31, 2014 (JP) 2014-017918

(51) Int. Cl. B41J 11/00; B41J 2/01

(52) U.S. Cl. CPC B41J 11/002; B41J 2/01

(57) ABSTRACT

The present invention suppresses variation in dot diameter. An inkjet printing apparatus performs control such that, in outward-way illumination intensity which is the illumination intensity of light to be radiated from an irradiating unit 11A onto ink ejected from a nozzle n on an outward way, and homeward-way illumination intensity which is the illumination intensity of light to be radiated from an irradiating unit 11B onto ink ejected from a nozzle n on a homeward way, the illumination intensity for which a time from when ink lands on a medium M to when the ink is irradiation with light is longer is higher than the illumination intensity for which the time is shorter, and the diameters of dots fall within a predetermined range.

### TECHNICAL FIELD

The present invention relates to an inkjet printing apparatus, a method for manufacturing a printed matter, a program, and a recording medium.

### BACKGROUND ART

PTL 1 discloses an inkjet printer, which has inkjet nozzles configured to output ultraviolet curing ink, and a pair of ultraviolet LEDs provided on both sides in the movement direction of the inkjet nozzles and configured to radiate ultraviolet light for hardening ultraviolet curing ink.

### CITATION LIST

### Patent Literature

PTL 1: JP-A-2005-144679

### SUMMARY

### Technical Problem

According to the inkjet printer disclosed in PLT 1, on the outward way of the inkjet nozzles, it is possible to eject ink and radiate ultraviolet light, and even on the homeward way, it is possible to eject ink and radiate ultraviolet light.

However, in a case of maintaining ultraviolet light for irradiation at constant illumination intensity, if a time on the outward way from when ink ejected from a certain nozzle lands on a recording medium to when the ink is irradiated with ultraviolet light is different from a time on the homeward way from when ink ejected from the corresponding nozzle lands on the recording medium to when the ink is irradiated with ultraviolet light, even though ink has been ejected from the same nozzle, the diameters of dots which are formed by that ink are different, resulting in a problem that the image quality deteriorates.

The present invention was made in view of this problem, and an object of the present invention is to suppress variation in dot diameter.

### Solution to Problem

In order to achieve the above described object, an inkjet printing apparatus according to the present invention includes: a head configured to eject ultraviolet light ink which hardens if being subjected to irradiation with light, onto a recording medium; irradiating means configured to irradiate the ink ejected from the head, with light; and an irradiation control means configured to control light irradiation of the irradiating means, wherein the head is configured to relatively reciprocate with respect to a mounting table for mounting the recording medium, and the plurality of irradiating means is disposed, such that they are aligned in the relative reciprocation direction and the head is disposed between two irradiating means, and is configured to relatively reciprocate in the same direction as the relative reciprocation direction with respect to the mounting table, together with the head, and the irradiation control means is configured to perform control such that, in outward-way illumination intensity which is the illumination intensity of light to be radiated from the irradiating means onto ink ejected from a certain nozzle of the head on the outward way of the reciprocating movement, and homeward-way illumination intensity which is the illumination intensity of light to be radiated from the irradiating means onto ink ejected from the certain nozzle on the homeward way of the reciprocating movement, the illumination intensity for which a time from when the ink lands on the recording medium to when the ink is irradiated with light is longer is higher than the illumination intensity for which a time from when the ink lands on the recording medium to when the ink is irradiated with light is shorter, and the diameters of dots formed by the ink landed on the recording medium at both of the outward-way illumination intensity and the homeward-way illumination intensity fall within a predetermined range.

According to the above described configuration, in a case of light for which the time from when ink lands to when the ink is irradiated with light is shorter, since the light is radiated with lower illumination intensity, it takes a long time for the ink to harden, and the diameters of dots increase in proportion to the hardening time. Meanwhile, in a case of light for which the time from when ink lands to when the ink is irradiated with light is longer, since the time from landing ink to irradiation is long, the diameters of dots increase in proportion to that time; however, since the light is radiated with higher illumination intensity, it takes a short time for ink to harden, and increases in the diameters of dots from start of irradiation to hardening are small. Therefore, it is possible to suppress variation in dot diameter, and it is possible provide a high-quality printed matter.

In the inkjet printing apparatus according to the present invention, the irradiation control means may be configured to control the irradiating means such that each dot is irradiated with light at least twice, and control the irradiating means such that the first irradiation is performed with such illumination intensity that the diameter of the dot is kept within the predetermined range and the ink is temporarily hardened, without being completely hardened, and the second irradiation is performed with such illumination intensity that the ink is completely hardened.

The temporarily hardened state is a state where ink can erode a recording medium. In other words, for example, in a case where temporarily hardened ink exists on a recording medium of, for example, vinyl chloride or polycarbonate, the ink can erode the recording medium. Thereafter, the ink is completely hardened, whereby it is possible to improve the adhesion between the ink and the recording medium. As a result, it is possible to provide a printed matter excellent in the adhesion between ink and the recording medium.

Also, a method for manufacturing a printed matter according to the present invention is a method for manufacturing a printed matter using an inkjet printing apparatus having a head configured to eject ultraviolet light ink which hardens if being subjected to irradiation with light, onto a recording medium, and irradiating means configured to irradiate the ink ejected from the head, with light, wherein the head is configured to relatively reciprocate with respect to amounting table for mounting the recording medium, and the irradiating means are disposed so as to be aligned with the head in the relative reciprocation direction, and is configured to relatively reciprocate in the same direction as the relative reciprocation direction with respect to the mounting table, together with the head, and outward-way illumination intensity which is the illumination intensity of light to be radiated from the irradiating means onto ink ejected from a certain nozzle of the head on the outward way of the reciprocating movement, and homeward-way illumination intensity which is the illumination intensity of light to be radiated from the irradiating means onto ink ejected from the certain nozzle of the head on the outward way of the reciprocating movement are set such that the illumination intensity for which a time from when the ink lands on the recording medium to when the ink is irradiated with light is longer is higher than the illumination intensity for which a time from when the ink lands on the recording medium to when the ink is irradiated with light is shorter, and the diameters of dots formed by the ink landed on the recording medium at both of the outward-way illumination intensity and the homeward-way illumination intensity fall within a predetermined range.

Due to the same effects as those of the above described inkjet printing apparatus according to the present invention, it is possible to suppress variation in dot diameter, and it is possible to provide a high-quality printed matter.

The inkjet printing apparatus according to each aspect of the present invention may be implemented by a computer. In this case, a program for making the computer operate as the irradiation control means of the inkjet printing apparatus, thereby implementing the inkjet printing apparatus in the computer, and a computer-readable recording medium retaining the corresponding program also fall within the scope of the present invention.

### Advantageous Effects of Invention

According to the present invention, an effect that it is possible to suppress variation in dot diameter is achieved.

### BRIEF DESCRIPTION OF DRAWINGS

FIG. 1 is a schematic diagram illustrating one mode of a printing method using an inkjet printing apparatus 1 according to an embodiment of the present invention.

FIG. 2 is a view for explaining the meaning of a phase “making a dot diameter fall within a predetermined range”.

FIG. 3 is a schematic diagram illustrating another mode of the printing method using the inkjet printing apparatus 1 according to the embodiment of the present invention.

### DESCRIPTION OF EMBODIMENTS

### <Configuration of Inkjet Printing Apparatus 1>

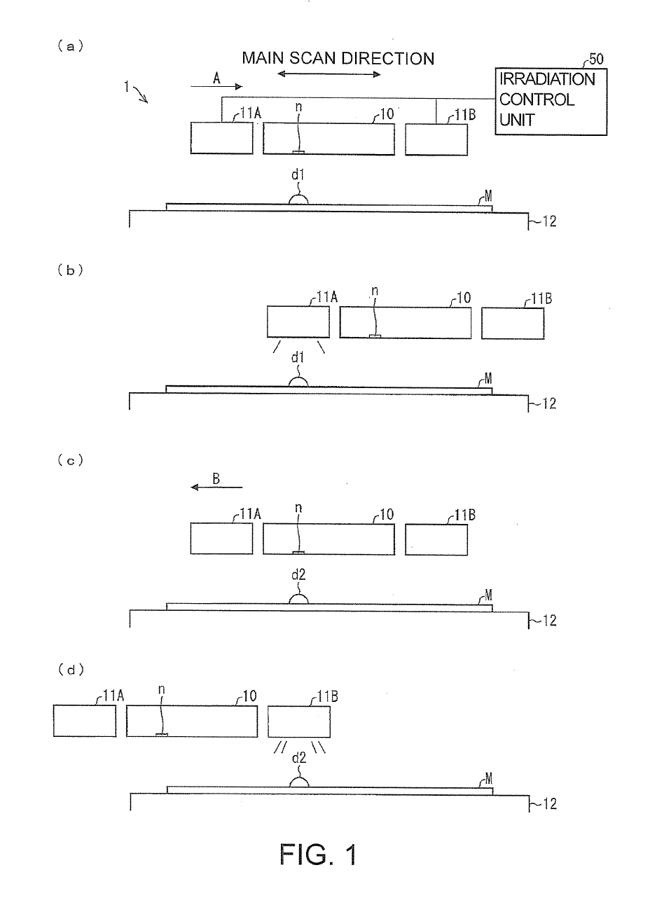

First, the configuration of an inkjet printing apparatus 1 will be described with reference to FIG. 1. FIG. 1 is a schematic diagram illustrating one mode of a printing method using the inkjet printing apparatus 1, and (a) of FIG. 1 schematically illustrates the configuration of the inkjet printing apparatus 1.

The inkjet printing apparatus 1 includes a head 10, an irradiating unit (an irradiating means) 11A, an irradiating unit 11B, amounting table 12, and an irradiation control unit (an irradiation control means) 50. Also, the inkjet printing apparatus 1 is configured to perform printing on a medium (a recording medium) M mounted on the mounting table 12.

[Head 10]

The head 10 is for ejecting ink which hardens if being subjected to irradiation with light, onto the medium M. Specifically, the head 10 has nozzles n formed therein, and ink is ejected from the nozzles n.

Ink needs only to be hardened by light radiated from the irradiating means, and for example, it is preferable that light for irradiation should be ultraviolet light and ink should be ultraviolet curing ink. In the present embodiment, a case where the head 10 ejects ultraviolet curing ink will be described.

Also, the head 10 is configured to reciprocate in a main scan direction as shown in FIG. 1. The main scan direction is a direction parallel to the direction of the mounting table 12 in a plane. Therefore, the head 10 relatively moves with respect to the mounting table 12. The configuration for moving the head 10 is not particularly limited. For example, it is possible to attach the head 10 to a bar, a rail, or the like extending in the main scan direction and move the head.

Also, in the present embodiment, a mode in which the head 10 moves in the main scan direction but the medium M does not move in the main scan direction will be described. However, the present invention is not limited thereto, and may have a configuration in which the head is fixed and a recording medium reciprocates in the main scan direction.

Also, a direction which is perpendicular to the main scan direction and is parallel to the direction of the mounting table in a plane is a sub scan direction. The medium M is conveyed in the sub scan direction.

[Irradiating Unit 11A and Irradiating Unit 11B]

The irradiating units 11A and 11B are for irradiating ink ejected from the head 10 with ultraviolet light. Ink ejected from head 10 is hardened by ultraviolet light radiated from the irradiating units 11A and 11B.

Also, the irradiating units 11A and 11B are disposed such that they are aligned in the main scan direction and the head is disposed between the irradiating unit 11A and the irradiating unit 11B. Therefore, the irradiating units 11A and 11B move in the same direction as the movement direction of the head 10, that is, in the main scan direction.

[Irradiation Control Unit 50]

The irradiation control unit 50 is for controlling light radiation of the irradiating units 11A and 113.

For example, the irradiation control unit sets outward-way illumination intensity which is the illumination intensity of light to be radiated from the irradiating unit 11A onto ink ejected from a certain nozzle of the head 10 on the outward way of reciprocating movement of the irradiating units 11A and 11B, and homeward-way illumination intensity which is the illumination intensity of light to be radiated from the irradiating unit 11B onto ink ejected from the certain nozzle in the homeward way of the reciprocating movement, such that the illumination intensity for which a time from when the ink lands on the medium M to when the ink is irradiated with light is longer is higher than the illumination intensity for which a time from when the ink lands on the medium M to when the ink is irradiated with light is shorter, and the diameters of dots formed by ink landed on the medium M at both of the outward-way illumination intensity and the homeward-way illumination intensity fall within a predetermined range.

Therefore, in a case of light for which the time from when ink lands to when the ink is irradiated with light is shorter, it takes a long time for the ink to harden, and the diameters of dots increase in proportion to the hardening time. Meanwhile, in a case of light for which the time from when ink lands to when the ink is irradiated with light is longer, since the time from landing ink to irradiation is long, the diameters of dots increase in proportion to that time; however, since the light is radiated with higher illumination intensity, it takes a short time for ink to harden, and increases in the diameters of dots from start of irradiation to hardening are small. Therefore, it is possible to suppress variation in dot diameter, and it is possible provide a high-quality printed matter.

In the irradiation control unit 50, on the basis of the type of ink, illumination intensities and times until start of irradiation for making dots of the ink have a certain diameter may be stored in advance. In this case, a user may input a desired dot diameter, or input desired image quality, and the irradiation control unit 50 may compute a dot diameter range for implementing the corresponding image quality, and control the irradiating units 11A and 11B such the diameters of dots fall within the corresponding range.

As examples of a method of changing the level of illumination intensity, a method of changing the outputs of the irradiating units, a method of changing the density of beams to be radiated onto a recording medium by tilting each irradiating unit, and a method of decreasing or increasing the distance between each irradiating unit and a recording medium can be taken. In the present embodiment, a case of using the method of changing the outputs will be described.

Also, the user may input illumination intensity or the like for obtaining a desired dot diameter, whereby the present invention can be implemented without depending on such irradiation control means. This method for manufacturing a printed matter also falls within the scope of the present invention. In other words, a method for manufacturing a printed matter according to the present invention is a method for manufacturing a printed matter using an inkjet printing apparatus having a head configured to eject ultraviolet light ink which hardens if being subjected to irradiation with light, onto a recording medium, and irradiating means configured to irradiate the ink ejected from the head, with light, wherein the head is configured to relatively reciprocate with respect to amounting table for mounting the recording medium, and the irradiating means are disposed so as to be aligned with the head in the relative reciprocation direction, and is configured to relatively reciprocate in the same direction as the relative reciprocation direction with respect to the mounting table, together with the head, and outward-way illumination intensity which is the illumination intensity of light to be radiated from the irradiating means onto ink ejected from a certain nozzle of the head on the outward way of the reciprocating movement, and homeward-way illumination intensity which is the illumination intensity of light to be radiated from the irradiating means onto ink ejected from the certain nozzle of the head on the outward way of the reciprocating movement are set such that the illumination intensity for which a time from when the ink lands on the recording medium to when the ink is irradiated with light is longer is higher than the illumination intensity for which a time from when the ink lands on the medium to when the ink is irradiated with light is shorter, and the diameters of dots formed by the ink landed on the recording medium at both of the outward-way illumination intensity and the homeward-way illumination intensity fall within a predetermined range.

Also, in this specification, as for the outward way and the homeward way, movement in one direction in reciprocating movement is referred to as the “outward way”, and the return way thereof is referred to as the “homeward way”. The outward way is not limited to movement of the head or the like from an initial position. For example, the head may first from the initial position to the other end. In this case, with reference to the position after the movement, movement to the initial position is referred to as the “outward way”, and movement to the other end is referred to as the “homeward way”.

<First Mode of Printing Method Using Inkjet Printing Apparatus 1>

Now, one mode of a printing method which is performed using the inkjet printing apparatus 1 will be described with reference to FIG. 1. Also, in (b) to (d) of FIG. 1, for simple explanation, the irradiation control unit 50 is not shown.

As shown in (a) of FIG. 1, first, the head 10 and the irradiating units 11A and 11B performs ejection of ink while moving in the direction of an arrow “A”. Here, the movement path in the direction of the arrow “A” is referred to as the outward way, and a dot which is formed by ink ejected from a nozzle “n” and landed on the medium M on the outward way is referred to as the dot d1.

Subsequently, as shown in (b) of FIG. 1, the dot d1 is irradiated with ultraviolet light from the irradiating unit 11A. As a result, the dot d1 hardens. At this time, the illumination intensity of ultraviolet light for irradiation on the dot d1 is lower than the illumination intensity of ultraviolet light of the irradiating unit 11B of (d) of FIG. 1 to be described below. Therefore, the dot d1 requires a longer time from start of irradiation with ultraviolet light to finish of hardening caused by the ultraviolet light, as compared to a dot d2 to be described below. At this time, the diameter of the dot d1 increases. However, at this time, the ultraviolet light of the irradiating unit 11A has such illumination intensity that the increased diameter of the dot d1 falls within a predetermined range. Thereafter, the medium M is conveyed in the sub scan direction.

Subsequently, as shown in (c) of FIG. 1, the head 10 and the irradiating units 11A and 11B move in the direction of an arrow “B”. This movement path is the homeward way. On the homeward way, ink is ejected from the nozzle “n”, whereby the dot d2 is formed on the medium M.

Subsequently, as shown in (d) of FIG. 1, the dot d2 is irradiated with ultraviolet light from the irradiating unit 11B. The distance between the nozzle “n” and the irradiating unit 11B is longer than the distance between the nozzle “n” and the irradiating unit 11A. Therefore, the time until start of irradiation on the dot d2 with ultraviolet light from the irradiating unit 11B is longer than the time until start of irradiation on the dot d1 with ultraviolet light from the irradiating unit 11A. For this reason, in the present embodiment, the illumination intensity of ultraviolet light from the irradiating unit 11B on the homeward way is set to be higher than the illumination intensity of ultraviolet light from the irradiating unit 11A on the outward way.

As a result, after irradiation with ultraviolet light starts, the dot d2 hardens faster as compared to the dot d1. For this reason, although the diameter of the dot d2 increases until irradiation with ultraviolet light starts, an increase in the diameter from start of irradiation with ultraviolet light to finish of hardening is smaller than that of the dot d1. Therefore, it is possible to suppress variation in the diameters of the dot d1 and the dot d2.

Also, the illumination intensity of the irradiating unit 11B has been set such that the diameter of the dot d2 falls within the predetermined range. The illumination intensity of the irradiating unit 11A also has been set such that the diameter of the dot d1 falls within the predetermined range. Since printing continues in the above described manner, the diameters of dots to form a printed image in the present embodiment are in the predetermined range, and variation is also suppressed. Therefore, it is possible to provide a high-quality printed matter.

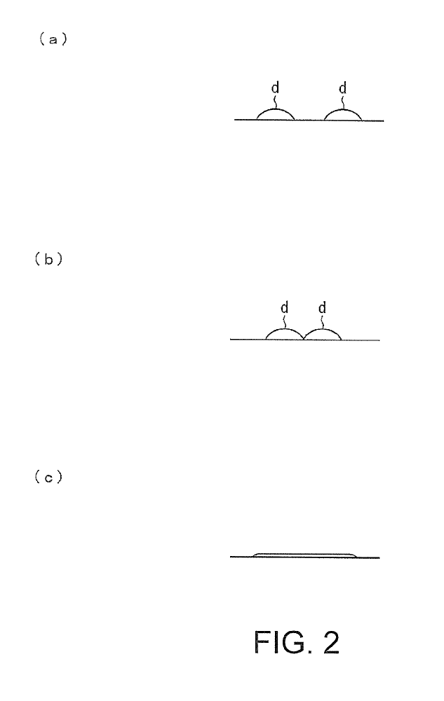

Now, the meaning of the phrase “making a dot diameter fall within the predetermined range” in this specification will be described with reference to FIG. 2. FIG. 2 is a view for explaining the meaning of the phrase “making a dot diameter fall within the predetermined range”.

In this specification, the phrase “making a dot diameter fall within the predetermined range” means making the diameter fall within the predetermined range while keeping the dot shape. For example, as shown in (a) of FIG. 2, each of a plurality of dots “d” exists in a hemispherical shape. In a case where this is seen from the side where there is the head, it is possible to recognize each dot “d” as a dot. Like this, since each dot keeps its shape without being deformed, it is possible to specify the diameter thereof. Making the diameter in that state fall within the predetermined range is expressed as making the dot diameter fall within the predetermined range. Also, as shown in (b) of FIG. 2, even though dots “d” are in contact with each other, each dot “d” needs to maintain its shape. However, in a case where dots have spread, whereby ink of the dots has been mixed as shown in (c) of FIG. 2, the shapes of the dots cannot be recognized any more. Therefore, ink which has spread to such an extent that it is impossible to recognize the shapes of dots is not included in the range of “making a dot diameter fall within the predetermined range”.

<Second Mode of Printing Method Using Inkjet Printing Apparatus 1>

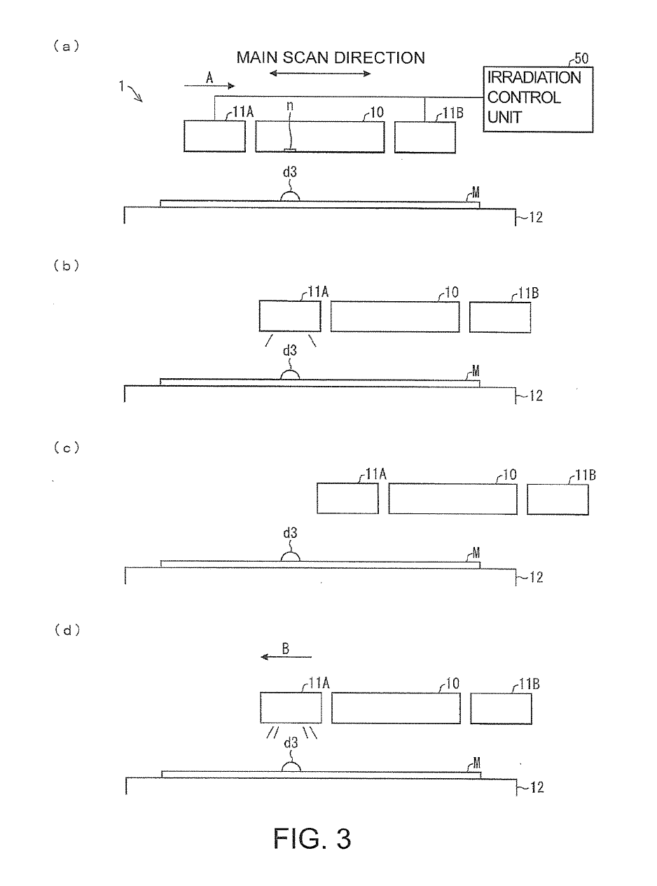

Now, another mode of the printing method which is performed using the inkjet printing apparatus 1 will be described with reference to FIG. 3.

In this mode, a case of temporarily hardening one dot and then completely hardening the dot will be described.

FIG. 3 is a schematic diagram illustrating anther mode of the printing method using the inkjet printing apparatus 1. Also, in (b) to (d) of FIG. 3, for easy explanation, the irradiation control unit 50 is not shown.

In the present mode, the irradiation control unit 50 is configured to control the irradiating units 11A and 11B such that one dot is irradiated with light at least twice, and controls the irradiating units 11A and 11B such that the first irradiation is performed with such illumination intensity that the dot diameter is maintained in the predetermined range and ink of the corresponding dot is temporarily hardened, without being completely hardened, and the second irradiation is performed with such illumination intensity that the ink is completely hardened. The temporarily hardened state is a state where ink can erode a recording medium. In other words, for example, in a case where temporarily hardened ink exists on a recording medium of, for example, vinyl chloride or polycarbonate, the ink can erode the recording medium. Thereafter, the ink is completely hardened, whereby it is possible to improve the adhesion between the ink and the recording medium. As a result, it is possible to provide a printed matter excellent in the adhesion between ink and the recording medium.

First, as shown in (a) of FIG. 3, the head 10 ejects ink from the nozzle “n” on the outward way where the head moves in the direction of an arrow “A”. As a result, a dot d3 is formed on the medium M.

Subsequently, as shown in (b) of FIG. 3, the irradiating unit 11A irradiates the dot d3 with ultraviolet light. Here, the irradiation control unit 50 controls the irradiating unit 11A such that the irradiating unit has such illumination intensity that the dot d3 does not completely harden and its diameter is maintained in the predetermined range. Also, temporal hardening is hardening ink such that dots are kept at viscosity lower than the viscosity after the ink is completed hardened. Those skilled in the art, it is possible to appropriately set such illumination intensity on the basis of the type ink and the like.

In this case, since the dot d3 has not completely hardened, the ink forming the dot d3 can erode the recording medium.

Subsequently, as shown in (c) of FIG. 3, the head 10 and the irradiating units 11A and 11B further moves, and performs printing on another portion.

Subsequently, as shown in (d) of FIG. 3, the irradiation control unit 50 controls the irradiating unit 11A such that the irradiating unit irradiates the dot d3 with ultraviolet light with such illumination intensity that the dot d3 is completely hardened, on the homeward way in which the irradiating unit moves in the direction of the arrow “B”. As a result, the dot d3 hardens.

In this mode, for easy explanation, only the case of performing temporal hardening and complete hardening has been described. However, this mode can be combined with the first mode described above, such that the diameters of all dots fall within the predetermined range, and ink is temporarily hardened, whereby it is possible to make the ink erode a recording medium, thereby improving the adhesion between the ink and the recording medium. In this case, it is possible to provide a printed matter having high image quality and high adhesion to the recording medium.

Although the modes using a control means such as the irradiation control unit 50 have been described above, it is also possible to compute required illumination intensities in advance, and input the illumination intensities for the outward way and the homeward way to the inkjet printing apparatus. In other words, a method for manufacturing a printed matter which is performed in an inkjet printing apparatus configured to perform irradiation at least twice, and includes a process of performing the first irradiation with such illumination intensity that the diameter of a dot is kept in a predetermined range and ink forming the corresponding dot is temporarily hardened, without being completed hardened, and performing the second irradiation with such illumination intensity that the corresponding ink is completely hardened also falls within the scope of the present invention.

[Implementation Example Using Software]

The irradiation control unit 50 of the inkjet printing apparatus 1 may be implemented by a logic circuit (hardware) formed on an integrated circuit (an IC chip) and so on, or may be implemented by software which is executed by a CPU (Central Processing Unit).

In the latter case, the inkjet printing apparatus 1 includes a CPU configured to execute commands of a program which is software for implementing its individual functions, a ROM (Read Only Memory) or a storage unit (referred to as the “auxiliary storage unit”) in which the above described program and a variety of data have been recorded so as to be readable in a computer (or a CPU), a RAM (Random Access Memory) for developing the program, and so on. In this case, the computer (or the CPU) reads the program from the auxiliary storage unit and executes the program, whereby the object of the present invention is achieved. As the auxiliary storage unit, a “non-transitory tangible medium”, such as a tape, a disk, a card, a semiconductor memory, or a programmable logic circuit, can be used. Also, the program may be supplied to the computer via an arbitrary transmission medium (such as a communication network or a broadcast wave) capable of transmitting the program. Also, the present invention can be implemented in the form of a data signal embedded as an embodiment of the program based on electronic transmission in a carrier wave.

The present invention is not limited to the above described embodiments, and can be variously modified within the scope defined by claims, and embodiments which can be obtained by appropriately combining the individual technical means disclosed in the different embodiments are also included in the technical scope of the present invention.

[Supplementary Information]

As described above, the inkjet printing apparatus 1 includes: the head 10 for ejecting ultraviolet curing ink which hardens if being subjected to irradiation with light, onto the medium M; the irradiating units 11A and 11B for irradiating ink ejected from the head 10, with light; and the irradiation control unit 50 for controlling light irradiation of the irradiating units 11A and 11B, wherein the head 10 is configured to relatively reciprocate with respect to the mounting table 12 for mounting the medium M, and the plurality of irradiating units 11A and 11B is disposed, such that they are aligned in the relative reciprocation direction and the head is disposed between the irradiating units 11A and 113, and is configured to relatively reciprocate in the same direction as the relative reciprocation direction with respect to the mounting table 12, together with the head 10, and the irradiation control unit 50 is configured to perform control such that, in outward-way illumination intensity which is the illumination intensity of light to be radiated from the irradiating unit 11A onto ink ejected from a certain nozzle of the head 10 on the outward way of the reciprocating movement, and homeward-way illumination intensity which is the illumination intensity of light to be radiated from the irradiating unit 113 onto ink ejected from the certain nozzle in the homeward way of the reciprocating movement, the illumination intensity for which a time from when the ink lands on the medium M to when the ink is irradiated with light is longer is higher than the illumination intensity for which a time from when the ink lands on the medium M to when the ink is irradiated with light is shorter, and the diameters of dots formed by ink landed on the medium M at both of the outward-way illumination intensity and the homeward-way illumination intensity fall within a predetermined range.

According to the above described configuration, in a case of light for which the time from when ink lands to when the ink is irradiated with light is shorter, since the light is radiated with lower illumination intensity, it takes a long time for the ink to harden, and the diameters of dots increase in proportion to the hardening time. Meanwhile, in a case of light for which the time from when ink lands to when the ink is irradiated with light is longer, since the time from landing ink to irradiation is long, the diameters of dots increase in proportion to that time; however, since the light is radiated with higher illumination intensity, it takes a short time for ink to harden, and increases in the diameters of dots from start of irradiation to hardening are small. Therefore, it is possible to suppress variation in dot diameter, and it is possible provide a high-quality printed matter.

In the inkjet printing apparatus 1, the irradiation control unit 50 is configured to control the irradiating unit 11A such that one dot d3 is irradiated with light at least twice, and controls the irradiating unit 11A such that the first irradiation is performed with such illumination intensity that the diameter of the dot d3 is maintained in the predetermined range and ink of the dot d3 is temporarily hardened, without being completely hardened, and the second irradiation is performed with such illumination intensity that the ink is completely hardened.

The temporarily hardened state is a state where ink can erode a recording medium. In other words, for example, in a case where temporarily hardened ink exists on a recording medium of, for example, vinyl chloride or polycarbonate, the ink can erode the recording medium. Thereafter, the ink is completely hardened, whereby it is possible to improve the adhesion between the ink and the recording medium. As a result, it is possible to provide a printed matter excellent in the adhesion between ink and the recording medium.

Also, an embodiment of a method for manufacturing a printed matter according to the present invention is a method for manufacturing a printed matter using the inkjet printing apparatus 1 including the head 10 for ejecting ultraviolet curing ink which hardens if being subjected to irradiation with light, onto the medium M, and the irradiating units 11A and 11B for irradiating the ink ejected from the head 10, wherein the head 10 is configured to relatively reciprocate with respect to the mounting table 12 for mounting the medium M, and the irradiating units 11A and 11B are disposed so as to be aligned in the relative reciprocation direction, and is configured to relatively reciprocate in the same direction as the relative reciprocation direction with respect to the mounting table 12, together with the head 10, and outward-way illumination intensity which is the illumination intensity of light to be radiated from the irradiating unit 11A onto ink ejected from a certain nozzle “n” of the head 10 on the outward way of the reciprocating movement, and homeward-way illumination intensity which is the illumination intensity of light to be radiated from the irradiating unit 11B onto ink ejected from the certain nozzle “n” of the head 10 in the homeward way of the reciprocating movement are set such that the illumination intensity for which a time from when the ink lands on the medium M to when the ink is irradiated with light is longer is higher than the illumination intensity for which a time from when the ink lands on the medium M to when the ink is irradiated with light is shorter, and the diameters of dots formed by ink landed on the medium NI at both of the outward-way illumination intensity and the homeward-way illumination intensity fall within a predetermined range.

It is possible to suppress variation in dot diameter, and it is possible provide high-quality printed matters.

### INDUSTRIAL APPLICABILITY

The present invention can be used in inkjet printing.

1. An inkjet printing apparatus comprising:
a head configured to eject ultraviolet light ink which hardens if being subjected to irradiation with light, onto a recording medium;
irradiators configured to irradiate the ink ejected from the head, with light; and
an irradiation controller configured to control light irradiation of the irradiators,
wherein the head is configured to relatively reciprocate with respect to a mounting table for mounting the recording medium,
the plurality of irradiators is disposed, such that they are aligned in the relative reciprocation direction and the head is disposed between two irradiators, and is configured to relatively reciprocate in the same direction as the relative reciprocation direction with respect to the mounting table, together with the head, and
the irradiation controller is configured to perform control such that, in outward-way illumination intensity which is the illumination intensity of light to be radiated from the irradiators onto ink ejected from a certain nozzle of the head on the outward way of the reciprocating movement, and homeward-way illumination intensity which is the illumination intensity of light to be radiated from the irradiators onto ink ejected from the certain nozzle on the homeward way of the reciprocating movement, the illumination intensity for which a time from when the ink lands on the recording medium to when the ink is irradiated with light is longer is higher than the illumination intensity for which a time from when the ink lands on the recording medium to when the ink is irradiated with light is shorter, and the diameters of dots formed by the ink landed on the recording medium at both of the outward-way illumination intensity and the homeward-way illumination intensity fall within a predetermined range.

2. The inkjet printing apparatus according to claim 1, wherein:
the irradiation controller s configured to control the irradiators such that each dot is irradiated with light at least twice, and
the irradiation controller controls the irradiators, such that the first irradiation is performed with such illumination intensity that the diameter of the dot is kept within the predetermined range and the ink is temporarily hardened, without being completely hardened, and the second irradiation is performed with such illumination intensity that the ink is completely hardened.

3. A method for manufacturing a printed matter using an inkjet printing apparatus having a head configured to eject ultraviolet light ink which hardens if being subjected to irradiation with light, onto a recording medium, and irradiators configured to irradiate the ink ejected from the head, with light, wherein:
the head is configured to relatively reciprocate with respect to a mounting table for mounting the recording medium,
the irradiators are disposed so as to be aligned with the head in the relative reciprocation direction, and is configured to relatively reciprocate in the same direction as the relative reciprocation direction with respect to the mounting table, together with the head, and
outward-way illumination intensity which is the illumination intensity of light to be radiated from the irradiators onto ink ejected from a certain nozzle of the head on the outward way of the reciprocating movement, and homeward-way illumination intensity which is the illumination intensity of light to be radiated from the irradiators onto ink ejected from the certain nozzle of the head on the outward way of the reciprocating movement are set such that the illumination intensity for which a time from when the ink lands on the recording medium to when the ink is irradiated with light is longer is higher than the illumination intensity for which a time from when the ink lands on the recording medium to when the ink is irradiated with light is shorter, and the diameters signal of dots formed by the ink landed on the recording medium at both of the outward-way illumination intensity and the homeward-way illumination intensity fall within a predetermined range.

4. (canceled)

5. A computer-readable recording medium retaining a program for making a computer function as the irradiation controller of the inkjet printing apparatus according to claim 1.

6. A computer-readable recording medium retaining a program for making a computer function as the irradiation controller of the inkjet printing apparatus according to claim 2.
